(19) United States
(12) Patent Application Publication
(10) Pub. No.: US 2023/0418701 A1
(43) Pub. Date: Dec. 28, 2023

(54) APPARATUS, METHOD, AND NON-TRANSITORY COMPUTER-READABLE MEDIUM FOR ANOMALY DETECTION

(71) Applicant: Hitachi, Ltd., Tokyo (JP)

(72) Inventors: Taku Wakui, Tokyo (JP); Mineyoshi Masuda, Tokyo (JP)

(73) Assignee: Hitachi, Ltd., Tokyo (JP)

(21) Appl. No.: 18/180,361

(22) Filed: Mar. 8, 2023

(30) Foreign Application Priority Data
Jun. 27, 2022 (JP) 2022-102396

(51) Int. Cl. G06F 11/07

(52) U.S. Cl. CPC G06F 11/076; G06F 11/0793

(57) ABSTRACT

An anomaly detection apparatus executes prediction processing to predict fluctuations of a normal range for a value of a parameter in a specified period, correction processing to identify an upper limit value at a local maximum point from fluctuating upper limit values of the predicted normal range, correct the upper limit values of the normal range, identify an upper limit value at a local minimum point from fluctuating upper limit values of the corrected normal range, and correct the upper limit values of the corrected normal range based on the upper limit value at the local minimum point identified, and anomaly detection processing to acquire a value of the parameter in the specified period, determine whether the value of the parameter acquired falls within the corrected normal range, and output predetermined information when determining that the value of the parameter acquired does not fall within the corrected normal range.

### CROSS-REELRENCE TO RELATED APPLICATION

This application claims priority pursuant to Japanese patent application No. 2022-102396, filed on Jun. 27, 2022, the entire disclosure of which is incorporated herein by reference.

### BACKGROUND

### Technical Field

The present disclosure relates to an apparatus, a method, and a non-transitory computer-readable medium for anomaly detection.

### Related Art

In operations management of an intonation technology (IT) system including various apparatuses such as a server and a storage, an anomaly detection function is necessary to promptly notify when a certain apparatus to be managed is not operating correctly. In a method typically used, chronological data called a performance value indicating, e.g., the status of an apparatus is periodically collected, and an anomaly is detected when an unusual behavior or value is observed. However, there are so many performance values to be collected in a large-scale IT system that it is difficult to monitor and analyze them manually.

Thus, anomaly detection technology employing artificial intelligence (AI)/machine learning (ML) technology, which has been markedly advancing in recent years, is being developed actively. This is a technology of detecting anomalies by creating a prediction model that has learned the behaviors of past performance values and calculating a threshold defining possible values for future performance values. Examples of the prediction model include a tree-based model using a decision tree or a regression tree, typified by random forest.

However, prediction of performance values using AI/ML has a problem where accurate prediction is difficult when a prediction model used is created immediately after a marked change occurred in a past performance value and created using that learning data. This is because performance values, which are learning data, include both features before the change and features after the change, and the prediction model learns both of those features at the same time. As time passes after the change in the performance value, a prediction model typically adapts to the features after the change, but immediately after the change, a prediction value from the prediction model is unstable.

In this regard, it is possible to create a prediction model adapted to features after the change by removing chronological data before the change from performance values used for learning and by learning only information after the change. However, immediately after the change, there are only a small number of pieces of chronological data after the change, and also, removing chronological data before the change makes it unable to predict features in a middle to long team period such as monthly or weekly.

In this way, in anomaly detection technology, after a marked behavioral change, prediction of a possible value for a performance value is difficult, and thus, cases of false positive detection and false negative detection increase. False positive detection lowers the reliability of anomaly detection, and false negative detection leads to delayed discovery of an anomaly.

Concerning such a problem, a technique disclosed in Japanese Patent Application Publication No. 2021-182287 sets any past period as a reference period, calculates a correction coefficient based on an actual measured value and a prediction value in the reference period, multiplies a prediction value in a target period by the correction coefficient, and thereby finds a corrected predicted value. An anomaly is determined by using a noimal range for a target period which has been set based on an upper-limit threshold and a lower-limit threshold of each of the prediction value and the corrected prediction value and determining whether the actual value is within the noimal range. Fluctuations which are difficult to predict can thus be handled, which enables reduction of unwanted anomaly detection.

The technique in Japanese Patent Application Publication No. 2021-182287 needs to set a reference period as a time slot for obtaining an actual value and a prediction value to be used for calculation of the correction coefficient. The reference period is set as a period where predicted and actual values of a performance value to be detected tend to deviate from each other and is aimed to calculate a proper correction coefficient. Thus, in a case of a performance value that tends to record a high value in a period where the performance value is most characteristic, e.g., business hours, the reference period may be set to business hours.

Meanwhile, it is difficult to set the reference period if there is no such characteristic period, and if there is a marked behavioral change outside the reference period, this change is not taken into consideration of the correction coefficient by which a predicted value is to be multiplied from then on. It is conceivable to set a wide reference period, but then the correction coefficient cannot be calculated properly, and the false positive detection reducing effect may lower.

Also, if there is a temporary spike in a performance value in the reference period, the technique in Japanese Patent Application Publication No. 2021-182287 extends the normal range even though the performance value is back to a usual value on the prediction date. Then, even if an abnormal event occurs on the prediction date and causes a large change in the performance value, an actual measured value may fall within the normal range, which may induce false negative detection.

### SUMMARY

The present disclosure has been made in view of such circumstances and has an object to provide an apparatus, a method, and a non-transitory computer-readable medium for anomaly detection capable of accurately detecting an anomaly in a parameter value with simple processing.

An aspect of the present disclosure to solve the above object is an anomaly detection apparatus comprising a processing device configured to execute prediction processing to predict fluctuations of a noimal range for a value of a parameter in a specified period, correction processing to identify an upper limit value at a local maximum point from fluctuating upper limit values of the predicted noimal range, correct the upper limit values of the noimal range based on the upper limit value at the local maximum point identified, identify an upper limit value at a local minimum point from fluctuating upper limit values of the corrected noimal range, and correct the upper limit values of the corrected normal range based on the upper limit value at the local minimum point identified, and anomaly detection processing to acquire a value of the parameter in the specified period, determine whether the value of the parameter acquired falls within the corrected noimal range, and output predetermined information when determining that the value of the parameter acquired does not fall within the corrected noimal range.

The present disclosure can accurately detect an anomaly in a parameter value with simple processing.

Configurations, advantageous effects, and the like not described above will become apparent in the following description of embodiments.

### BRIEF DESCRIPTION OF THE DRAWINGS

FIG. 1 is a diagram showing an example configuration of an anomaly detection system of the present embodiment.

FIG. 2 is a diagram showing an example of a prediction data table.

FIG. 3 is a diagram showing an example of an anomaly recording table.

FIG. 4 is a flowchart illustrating an overview of anomaly detection processing.

FIG. 5 is a diagram showing an example of a performance data table.

FIG. 6 is a diagram showing an example of an anomaly detection management screen.

FIG. 7 is a diagram showing an example of a correction parameter table.

FIG. 8 is a diagram showing an example of a filter parameter table.

FIG. 9 is a flowchart illustrating details of a prediction model generation processing.

FIG. 10 is a flowchart illustrating details of normal range calculation processing.

FIG. 11 is a flowchart illustrating details of normal range correction processing.

FIG. 12 is a flowchart illustrating details of corrected normal range calculation processing.

FIGS. 13A through 13D are diagrams illustrating what is performed in the corrected normal range calculation processing.

FIG. 14 is a flowchart illustrating details of anomaly detection processing.

FIG. 15 is a diagram showing an example of the relation between the behavior of actual measured values of a performance parameter and a normal range predicted by a prediction model.

FIG. 16 is diagram showing an example of the relation between the behavior of actual measured values of a performance parameter and a normal range corrected by the corrected normal range calculation processing.

### DETAITFD DESCRIPTION

An embodiment of the present disclosure is described in detail below with reference to the drawings.

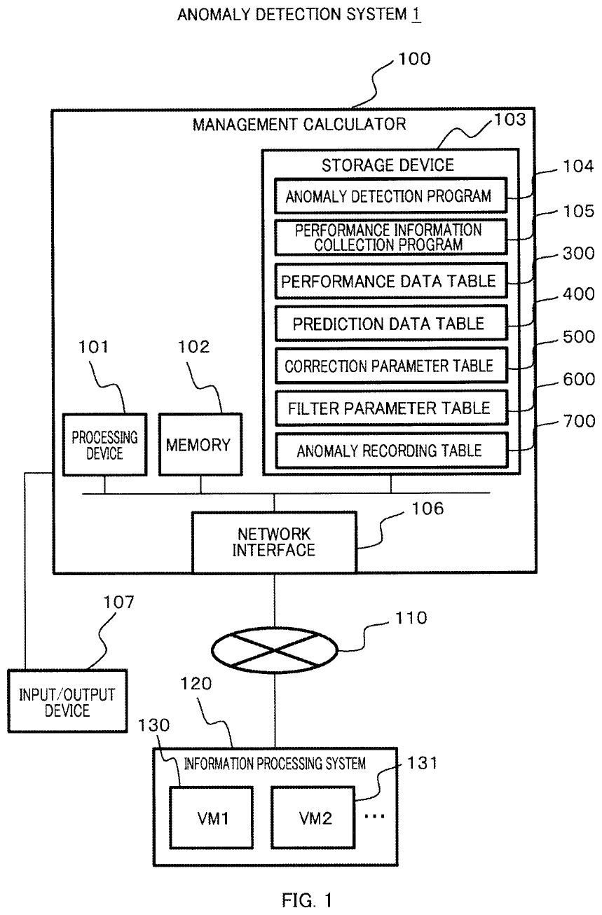

FIG. 1 is a diagram showing an example configuration of an anomaly detection system 1 of the present embodiment. The anomaly detection system 1 is configured including a management calculator 100 (an anomaly detection apparatus), an information processing system 120, and an input/output device 107.

The information processing system 120 is a target for which to detect an anomaly. The information processing system 120 is configured including a plurality of virtual calculators 130, 131 (VM1, VM2, . . . ; VM stands for a virtual machine) and software (not shown) such as an operating system (OS) that operates on the virtual calculators 130, 131. The virtual calculators 130, 131 in the information processing system 120 are calculators that have constituents similar to those in the management calculator 100. Although configured of a virtual calculator in the present embodiment, the information processing system 120 may be a physical calculator.

The management calculator 100 is an information processing apparatus that detects whether there is any anomaly occurring in the virtual calculators 130, 131 operating in the information processing system 120 by collecting values of parameters indicative of the operation statuses of the virtual calculators 130, 131 (such parameters are hereinafter referred to as performance parameters).

The management calculator 100 and the information processing system 120 are connected to each other by a wired or wireless communication network 110 such as, for example, the Internet, a local area network (LAN), a wide area network (WAN), or a dedicated line.

Although the management calculator 100 and the information processing system 120 are connected to the same communication network 110 in the present embodiment, the management calculator 100 may be connected to a communication network different from the one to which the anomaly detection target is connected. For example, all or some of programs for the management calculator 100 may be implemented by, for example, a service provided by a cloud service via an application programming interface (API) or the like. In this case, the administrator or the like of the information processing system 120 can check anomaly detection results from anywhere by, for example, using a browser and accessing the management calculator 100 running on a cloud via the Internet.

The input/output device 107 is famed by an output device such as a display and a touch panel and an input device such as a keyboard, a mouse, or a touch panel, the output and input devices being connected to the management calculator 100. For example, the input/output device 107 receives information inputted by a user, stores the information in the management calculator 100, and displays, e.g., information on processing results obtained by the management calculator 100.

Next, the management calculator 100 includes, e.g., a processing device 101 such as a central processing unit (CPU), memory 102 such as random-access memory (RAM) or read-only memory (ROM), a storage device 103 such as a hard disk drive (HDD) or a solid-state drive (SSD), and a network interface 106 famed by a network interface card (NIC), a wireless communication module, a universal serial interface (USB) module, a serial communication module, or the like.

The management calculator 100 stores therein an anomaly detection program 104, a performance information collection program 105, a performance data table 300, a prediction data table 400, and a correction parameter table 500, a filter parameter table 600, and an anomaly recording table 700.

The anomaly detection program 104 performs prediction processing to predict fluctuations of a normal range for a value of a performance parameter in a user-specified period for which to predict the normal range for the performance parameter (hereinafter referred to as a prediction period).

In the present embodiment, fluctuations of a normal range are calculated by a prediction model which is a learned model. The prediction model is built based on an algorithm of, for example, a neural network, a decision tree, a random forest, or a support vector machine (SVM). A neural network has an input layer to which data is inputted, one or more intermediate layers (hidden layers) that extract a feature value from the input data and output the feature value, and an output layer that outputs output data, and is for example a convolution neural network (CNN). Although the prediction model in the present embodiment is a learned model based on a decision tree, there is no intention of limiting the algorithm of the prediction model thereto. Also, the prediction model is not limited to a learned model and may be any numerical model that takes a prediction period for a performance parameter as an input value and gives the normal range for a value of the performance parameter in the prediction period as an output value.

The anomaly detection program 104 identifies upper limit values at local maximum points (to be described in detail later) from fluctuating upper limit values of the normal range thus predicted and corrects the upper limit values of the normal range based on the upper limit values at the local maximum points thus identified (this processing is hereinafter referred to as smoothing by interpolation between local maximum values or first correction processing). Next, the anomaly detection program 104 identifies upper limit values at local minimum points from fluctuating upper limit values of the corrected normal range and further corrects the upper limit values of the normal range based on the upper limit values at the local minimum points thus identified (this processing is hereinafter referred to as smoothing by interpolation between local minimum values or second correction processing). Note that the smoothing by interpolation between local maximum values and the smoothing by interpolation between local minimum values are hereinafter collectively referred to as corrected normal range calculation processing.

Further, the anomaly detection program 104 acquires a value of the performance parameter in the prediction period, determines whether the value of the performance parameter acquired is within the normal range corrected as above, and if determining that the value of the performance parameter acquired is not within the corrected normal range, outputs a determination result indicating that there is an anomaly.

The performance information collection program 105 receives values of a performance parameter measured in the information processing system 120 from the information processing system 120.

The performance data table 300 is a database storing the values of the performance parameter received from the information processing system 120.

The prediction data table 400 is a database storing intonation on fluctuations of the normal range calculated by the prediction model.

The correction parameter table 500 is a database storing parameters related to methods for correcting the upper limit values of the normal range (correction parameters).

The filter parameter table 600 is a database storing parameters for use in determining an anomaly in a performance parameter (filter parameters).

The anomaly recording table 700 is a database storing results of performance parameter anomaly determination.

Now, details of the prediction data table 400 and the anomaly recording table 700 are described.

### (Prediction Data Table)

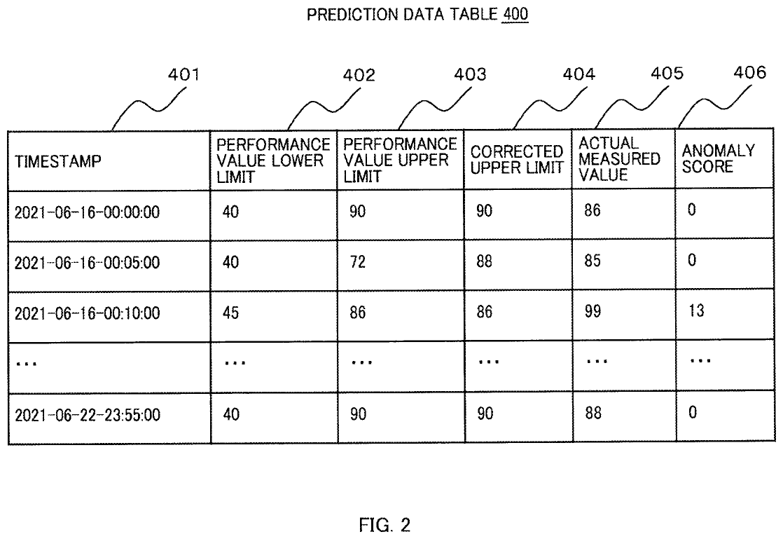

FIG. 2 is a diagram showing an example of the prediction data table 400. The prediction data table 400 has the following data items: timestamp 401 to set dates and times within a period for predicting a normal range (a prediction period), performance value lower limit 402 to set the lower limit values of the normal range for a value of a performance parameter (hereinafter referred to as a performance value) on the respective dates and times in the prediction period, performance value upper limit 403 to set the upper limit values of the normal range for the performance value on the respective dates and times in the prediction period, corrected upper limit 404 to set upper limit values obtained by performing corrected normal range calculation processing on the upper limit values of the normal range (corrected upper limit values), actual measured value 405 to set performance values measured on the respective dates and times in the prediction period (measured values), and anomaly score 406 to set anomaly scores for the respective dates and times in the prediction period.

Note that a method for calculating the values for the performance value lower limit 402 and the performance value upper limit 403 is not limited to a particular method. For example, in a case of ensemble learning using decision trees (random forest), a method employed may be one that takes given quantiles in a distribution of predicted values of performance values obtained from the decision trees and sets them as the performance value lower limit and the performance value upper limit or may be one that adds and subtracts values to which a performance value can fluctuate to and from the median of a distribution of predicted values and sets the obtained values as the performance value lower limit and the performance value upper limit, respectively.

If the corrected normal range calculation processing is not executed, what is stored in the corrected upper limit 404 is the value in the performance value upper limit 403 on the same record.

Stored in the actual measured value 405 is a value extracted from VM information 302 in the performance data table 300.

The anomaly score is a value indicating the degree in which the value in the actual measured value 405 deviates from the normal range (the upper limit value or the lower limit value) (a difference). For example, if the value in the actual measured value 405 at a certain time falls within the normal range (i.e., is equal to or above the performance value lower limit 402 and equal to or below the corrected upper limit 404), the anomaly score 406 for this time is zero. If the value in the actual measured value 405 is above the value in the corrected upper limit 404, the anomaly score for this time is a positive value obtained by subtracting the value in the corrected upper limit 404 from the value in the actual measured value 405. If the value in the actual measured value 405 is below the value in the performance value lower limit 402, the anomaly score for this time is a negative value obtained by subtracting the value in the performance value lower limit 402 from the value in the actual measured value 405. If the anomaly score exceeds a predetermined positive or negative threshold, the performance value is determined to be abnormal. Note that the method for calculating an anomaly score described above is merely an example, and the anomaly score may be anything that indicates the degree in which the actual measured value deviates from the normal range.

### (Anomaly Recording Table 700)

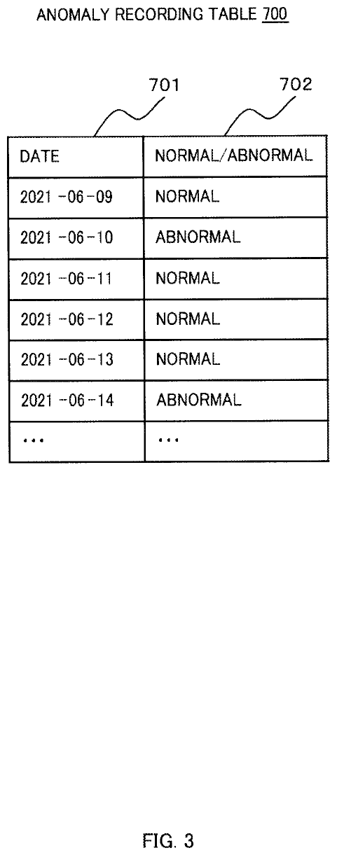

FIG. 3 is a diagram showing an example of the anomaly recording table 700. The anomaly recording table 700 has the following data items: date 701 to set a target date and abnormal/normal 702 to set information indicating whether any anomaly is determined on that date. This anomaly recording table 700 is also used for determination of whether correction by noimal range correction processing to be described later is necessary.

The above-described programs for the management calculator 100 are executed when the processing device 101 reads them from the memory 102 or the storage device 103. Also, each of the programs can be, for example, recorded in a portable or fixed non-transitory computer-readable medium and distributed.

Next, processing pertained in the anomaly detection system is described.

### <Anomaly Detection Processing>

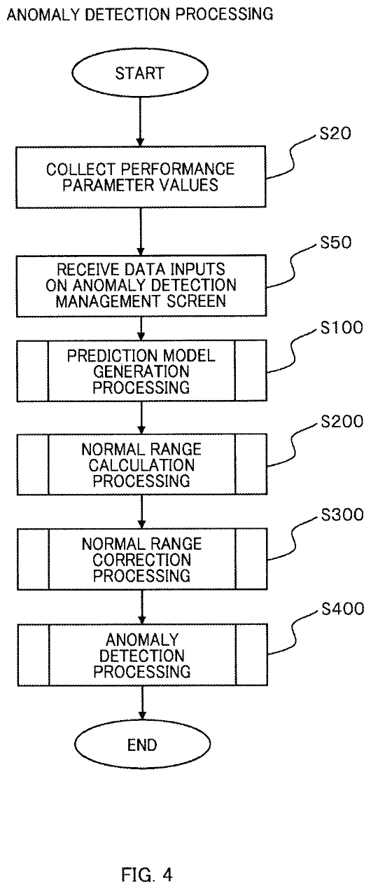

FIG. 4 is a flowchart describing an overview of the anomaly detection processing performed in the anomaly detection system. For example, the anomaly detection processing is executed when the management calculator 100 receives a predeteimined input from a user or at a predeteimined timing (e.g., at a predeteimined time or at a predeteimined time interval).

First, the perfoimance infoimation collection program 105 collects values of a performance parameter from the infoimation processing system 120 (S20).

For example, the performance infoimation collection program 105 receives, from the infoimation processing system 120, performance parameter history infoimation on the virtual calculators 130, 131 (VMs) running on the infoimation processing system 120, such as CPU usage and memory consumption, measured by measurement agents (not shown) operating on the VMs. Note that the perfoimance information collection program 105 may collect values of the performance parameters directly from the VMs without using the measurement agents (an agentless method).

Note that the processing in S20 may be repeated at predetermined timing (e.g., at a predetermined time or at a predetermined time interval) independently from the anomaly detection processing.

### (Performance Data Table)

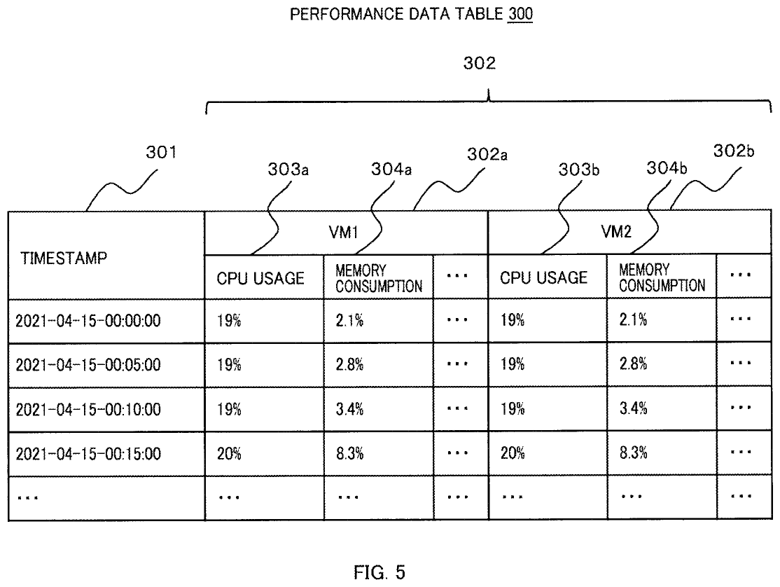

FIG. 5 is a diagram showing an example of the performance data table 300. The performance data table 300 has the following data items: timestamp 301 to set dates and times on which values of the performance parameters for each VM were measured and VM information 302 (302a, 302b, . . . ) to set information on the performance parameters of each VM. Each column of the VM information 302 has the following data subitems: CPU usage 303 (303a, 303b, . . . ) to set information on the CPU usage of the corresponding VM and memory consumption 304 (304a, 304b, . . . ) to set information on the memory consumption of the corresponding VM. Note that the performance parameters shown in FIG. 5 are merely examples.

Next, as shown in FIG. 4, the anomaly detection program 104 displays an anomaly detection management screen 200 to be described next and receives user-inputted information necessary to detect anomalies in the information processing system 120 (the user is, e.g., an administrator of the information processing system 120) (S50).

### (Anomaly Detection Management Screen)

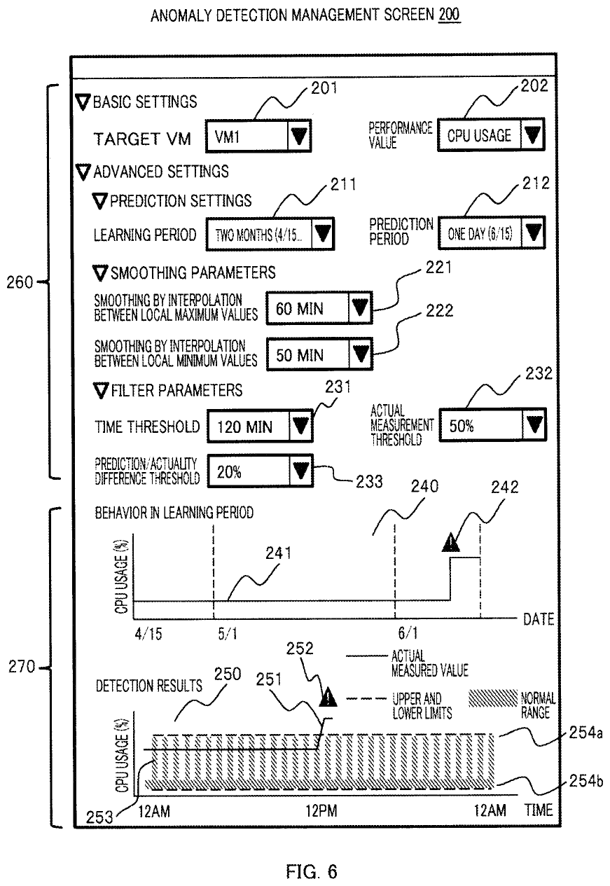

FIG. 6 is a diagram showing an example of the anomaly detection management screen 200. The anomaly detection management screen 200 includes an input part 260 and a result display part 270. The input part 260 is a region for receiving set values necessary for anomaly detection inputted from a user, and the result display part 270 is a region for displaying anomaly detection results.

The input part 260 includes the following selection fields: a target VM selecting part 201, a performance value selecting part 202, a learning period setting part 211, a prediction period setting part 212, a local maximum value smoothing maximum time interval setting part 221, a local minimum value smoothing maximum time interval setting part 222, a time period threshold setting part 231, an actual measured threshold setting part 232, and a prediction-actuality difference threshold setting part 233.

The target VM selecting part 201 receives a selection of a VM for which to detect an anomaly (hereinafter referred to as a target VM), the selection being made by a user from a list of VMs running on the information processing system 120.

The performance value selecting part 202 receives a selection of a performance parameter used for anomaly detection, the selection being made by a user from various performance parameters measured for the target VM.

Note that the target VM selecting part 201 and the performance value selecting part 202 may receive selections of a plurality of target VMs and a plurality of performance parameters, respectively, from a user.

The learning period setting part 211 and the prediction period setting part 212 receive user-inputted parameters related to learning and usage of a prediction model that calculates a normal range.

Specifically, the learning period setting part 211 receives a learning period specified and inputted by a user, the learning period being a period related to the performance parameter used for learning of a prediction model. The prediction period setting part 212 receives a period for which the prediction model predicts performance values (a prediction period) specified and inputted by a user.

Note that the dates and times in the timestamp 401 of the prediction data table 400 are stored based on the prediction period specified in the prediction period setting part 212. For instance, in a case of calculating a normal range for one day using a prediction model learned based on chronological data on performance values in two months from April 15th to June 14th, the prediction period is one day on June 15th. Then, dates and times at any time interval (a 5-minute interval in FIG. 2) in the prediction period are stored in the timestamp 401.

The local maximum value smoothing maximum time interval setting part 221 and the local minimum value smoothing maximum time interval setting part 222 receive correction parameters inputted by a user. The correction parameters are stored in the correction parameter table 500. Specifically, the local maximum value smoothing maximum time interval setting part 221 receives a local maximum value smoothing maximum time interval inputted from a user, and the local minimum value smoothing maximum time interval setting part 222 receives a local minimum value smoothing maximum time interval from a user. Details of the local maximum value smoothing maximum time interval and the local minimum value smoothing maximum time interval will be described later.

The time period threshold setting part 231, the actual measured threshold setting part 232, and the prediction-actuality difference threshold setting part 233 receive user-inputted filter parameters which are parameters used to determine whether there is an anomaly. The filter parameters are stored in the filter parameter table 600.

Specifically, the time period threshold setting part 231 receives the minimum continuance time period inputted from a user, the actual measured threshold setting part 232 receives the minimum parameter value inputted from a user, and the prediction-actuality difference threshold setting part 233 receives the minimum anomaly score inputted from a user.

The minimum continuance time period is a threshold of a continuance time period for which an anomaly score stays above a predetermined threshold which is necessary to determine that there is an anomaly. The minimum parameter value is the minimum value of a performance parameter which is necessary to determine that there is an anomaly. The minimum anomaly score is a threshold for an anomaly score which is necessary to determine that there is an anomaly. These parameters are specified by a numerical value, a percentage, or the like.

Details of the result display part 270 will be described later.

### (Correction Parameter Table)

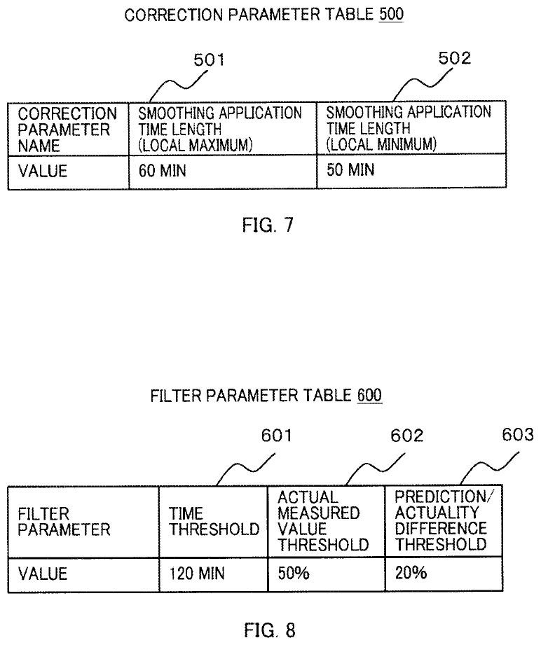

Next, FIG. 7 is a diagram showing an example of the correction parameter table 500. The correction parameter table 500 stores filter parameters. Specifically, the correction parameter table 500 has the following data items: smoothing application time length (local maximum) 501 to set a local maximum value smoothing maximum time interval and smoothing application time length (local minimum) 502 to set a local minimum value smoothing maximum time interval. Values specified in the local maximum value smoothing maximum time interval setting part 221 and the local minimum value smoothing maximum time interval setting part 222 of the anomaly detection management screen 200 are stored in the correction parameter table 500.

### (Filter Parameter Table)

FIG. 8 is a diagram showing an example of the filter parameter table 600. The filter parameter table 600 stores filter parameters. The filter parameters are parameters used to remove a small deviation and extract a large deviation when an actual measured value deviates from the normal range. If it is determined by this filter that there is a large deviation, i.e., there is an anomaly, “abnormal” is recorded in the abnormal/normal 702 for the corresponding date in the anomaly recording table 700.

The filter parameter table 600 has the following data items: time period threshold 601 to set the minimum continuance period, actual measured value threshold 602 to set the minimum parameter value, and prediction/actuality difference threshold 603 to set the minimum anomaly score. In the example shown in FIG. 8, “120 minutes” is set in the time period threshold 601, and thus, an anomaly is detected when the anomaly score deviation state continues for 120 minutes or longer.

Next, as shown in FIG. 4, the anomaly detection program 104 and the performance information collection program 105 execute prediction model generation processing S100 to acquire the performance values of the information processing system 120 and create a prediction model. Details of the prediction model generation processing S100 will be described later.

The anomaly detection program 104 executes normal range calculation processing S200 to calculate the normal range for performance values based on the prediction model created in S100. Details of the normal range calculation processing S200 will be given later.

The anomaly detection program 104 determines whether normal range correction processing needs to be executed on the normal range calculated by the normal range calculation processing S200, and if determining that the normal range correction processing is needed, executes normal range correction processing S300 to execute normal range correction processing. Details of the normal range correction processing S300 will be given later.

The anomaly detection program 104 executes anomaly detection processing S400 to perform anomaly detection based on the normal range calculated by the normal range correction processing S300 (hereinafter referred to as a corrected normal range) and record results of the anomaly detection in the anomaly recording table 700. Details of the anomaly detection processing S400 will be described later.

Next, details of the processing described above are described.

### <Prediction Model Generation Processing>

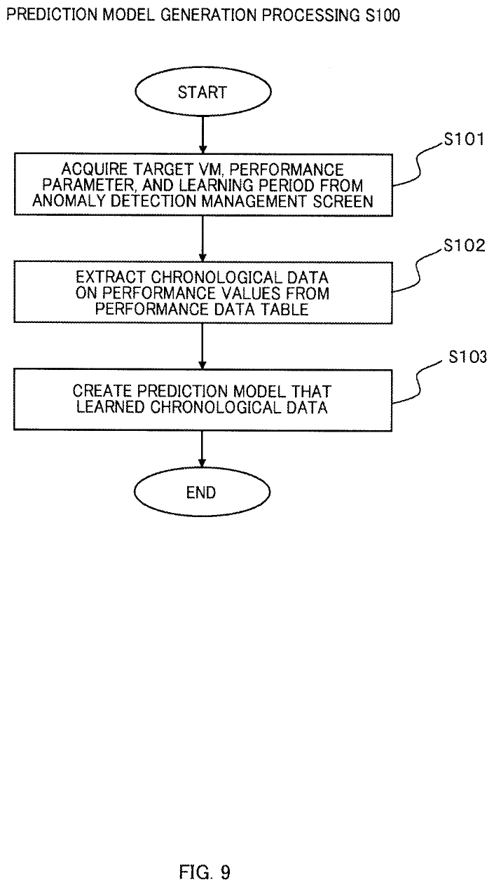

FIG. 9 is a flowchart illustrating the details of the prediction model generation processing S100.

First, the anomaly detection program 104 acquires a target VM, a performance parameter, and a learning period from the target VM selecting part 201, the performance value selecting part 202, and the learning period setting part 211, respectively, of the anomaly detection management screen 200 (S101).

The anomaly detection program 104 extracts chronological data on performance values from the performance data table 300, the chronological data being identified based on the information acquired in S101 (S102). In other words, the anomaly detection program 104 acquires data on performance values measured for the target VM in the learning period.

The anomaly detection program 104 create a prediction model using the chronological data on performance values acquired in S102 as learning data (S103). The prediction model generation processing S100 thus ends.

A prediction model is a learned model that takes a performance value measurement time (timestamp) as an explanatory variable (an input value) and gives a performance value measured at the time indicated by the timestamp as an objective variable (an output value). The timestamp information used as an explanatory variable may further include a year-month-date, a time of the day, a day of the week, the number of a week in the month, an attribute indicating if it is a weekday or a holiday, and the like.

Also, in the present embodiment, the prediction model is created for each column of performance information in the performance data table 300. For instance, in a case where two performance parameters are measured for each of two VMs and are all targeted for anomaly detection, four of the prediction models for predicting a normal range in one prediction period are created. Then, as a result of creating one prediction model for one performance parameter for each of the VMs, the same number of prediction data tables 400 as the prediction models are created.

### <Noimality Range Calculation Processing>

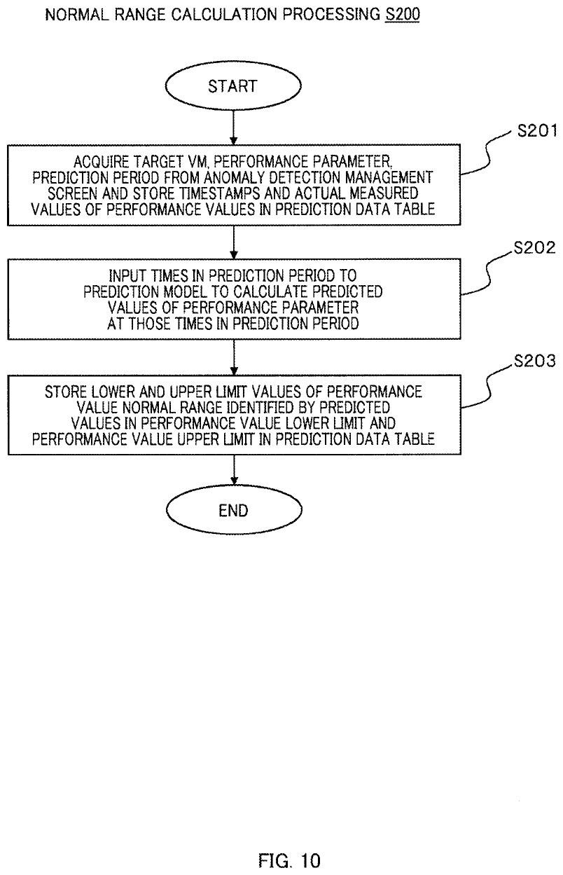

FIG. 10 is a flowchart illustrating details of the normal range calculation processing S200.

First, the anomaly detection program 104 acquires the target VM, the performance parameter, and the prediction period from the target VM selecting part 201, the performance value selecting part 202, and the prediction period setting part 212, respectively, of the anomaly detection management screen 200. The anomaly detection program 104 then stores, in the prediction data table 400, chronological data on performance values in the prediction period identified by the information acquired (S201).

Specifically, in the timestamp 401 of new records of the prediction data table 400, the anomaly detection program 104 stores times in the prediction period. The anomaly detection program 104 also acquires, from the performance data table 300, values of the performance parameter at the respective times in the prediction period that correspond to the target VM and the performance parameter acquired, and stores the acquired values of the performance parameter in the actual measured value 405.

Next, the anomaly detection program 104 inputs the prediction period in the records of the prediction data table 400 created in S201 into the prediction model created by the prediction model generation processing S100 and thereby acquires a range of possible performance values (a normal range) for each of the times in the prediction period (S202). Note that the prediction model is thereby updated based on the data in the specified prediction period.

The anomaly detection program 104 stores, in the prediction data table 400, information on the fluctuations of the normal range for the performance parameter that are identified based on the results outputted from the prediction model (S203).

Specifically, in the performance value lower limit 402 and the performance value upper limit 403 of the prediction data table 400, the anomaly detection program 104 stores the lower limit value and the upper limit value of the performance values identified from the performance values acquired in S202. The normal range calculation processing S200 thus ends.

### <Normality Range Correction Processing S300>

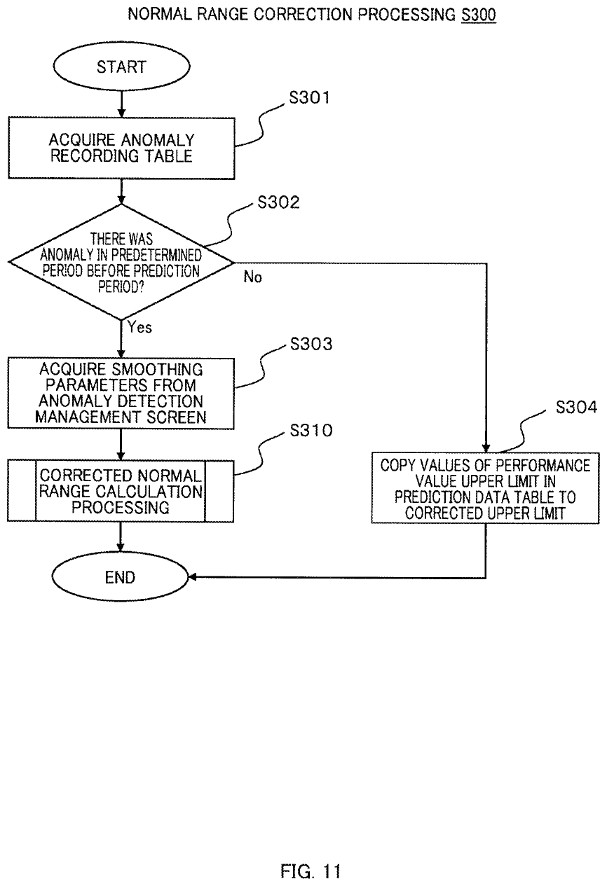

FIG. 11 is a flowchart illustrating details of the normal range correction processing S300.

The anomaly detection program 104 acquires the data in the anomaly recording table 700 (S301). The anomaly detection program 104 then determines, based on the data acquired, whether there was an anomaly in a performance value in a predetermined period immediately before the prediction period (S302).

Specifically, the anomaly detection program 104 identifies a period extending from a time immediately before the earliest one of the times stored in the timestamp 401 of the prediction data table 400 back to a time a predetermined period before that (one week in the present embodiment). The anomaly detection program 104 then extracts, from the anomaly recording table 700, the abnormal/normal 702 on each of the records in the period identified above and determines whether there is a record in which “abnormal” is recorded.

Although the anomaly detection program 104 checks for anomalies determined in the past week in the present embodiment, this period is not limited to one week and may be adjusted according to the length of the period for the performance parameter used for learning of the prediction model.

If any of the performance values is determined to be abnormal (S302: Yes), the anomaly detection program 104 executes processing of S303, and if none of the performance values is determined to be abnormal (S302: No), the anomaly detection program 104 executes processing of S304.

In S303, the anomaly detection program 104 acquires correction parameters (a local maximum value smoothing maximum time interval and a local minimum value smoothing maximum time interval) from the local maximum value smoothing maximum time interval setting part 221 and the local minimum value smoothing maximum time interval setting part 222, respectively, of the anomaly detection management screen 200.

The anomaly detection program 104 then executes corrected normal range calculation processing S310 to calculate a corrected normal range based on the local maximum value smoothing maximum time interval and the local minimum value smoothing maximum time interval and store the corrected normal range in the prediction data table 400. Details of the corrected normal range calculation processing S310 will be described later. The normal range correction processing S300 thus ends.

Meanwhile, in S304, the anomaly detection program 104 does not calculate a corrected normal range and stores the current upper limit performance values in the prediction data table 400. Specifically, the anomaly detection program 104 copies the values of the performance value upper limit 403 of the respective records in the prediction data table 400 and stores them in the corrected upper limit 404 of the corresponding records. The normal range correction processing S300 thus ends.

### <Corrected Normality Range Calculation Processing>

FIG. 12 is a flowchart illustrating the details of the corrected normal range calculation processing S310. Hereinbelow, X and Y respectively denote the local maximum value smoothing maximum time interval and the local minimum value smoothing maximum time interval acquired in S303.

First, the anomaly detection program 104 copies the value of the performance value upper limit 403 of each record in the prediction data table 400 and stores the copy in the corrected upper limit 404 of the same record (S311).

The anomaly detection program 104 then corrects the upper limit values of the normal range by performing smoothing by interpolation between local maximum values (S312 to S316).

Specifically, the anomaly detection program 104 stores the performance value for the first time in the prediction data table 400 as a first local maximum point (S312). Specifically, in the prediction data table 400, the anomaly detection program 104 takes the value of the corrected upper limit 404 on the record with the timestamp 401 indicating the earliest time, links the value to that time, and stores the value and its corresponding time as a “local maximum point 1.”

The anomaly detection program 104 takes the local maximum value (or the maximum value) from the perfoimance values in a period from the time of the first local maximum point to a time which is X after that time, and stores the value and its corresponding time as a second local maximum point (S313). Specifically, the anomaly detection program 104 identifies fluctuations of the perfoimance values within X starting from the time of the “local maximum point 1” by referring to the records in the prediction data table 400, links, to its corresponding time, the local maximum value (or the maximum value) at a local maximum point closest to the first local maximum point as indicated by the fluctuations, and stores the local maximum value and its corresponding time as a “local maximum point 2.” In other words, the first local maximum point and the second local maximum point are two local maximum points adjacent to each other in X.

The anomaly detection program 104 calculates performance values in between the time of the first local maximum point to the time of the second local maximum point in the prediction data table 400 based on the first and second local maximum points and stores the calculated values in the prediction data table 400 (S314).

Specifically, for example, the anomaly detection program 104 perforins linear interpolation based on the first and second local maximum points. More specifically, the anomaly detection program 104 generates a formula for a line segment connecting the first local maximum point to the second local maximum point (a time−performance value formula), applies the generated line segment formula to each of the times in the timestamp 401 of the records in which times in between the time of the first local maximum point and the time of the second local maximum point are registered in the timestamp 401 in the prediction data table 400, thereby calculates the performance values at those times, and sets the calculated performance values in the corrected upper limit 404 of the corresponding records.

Note that the anomaly detection program 104 may perform interpolation processing other than the linear interpolation. For example, the anomaly detection program 104 may use, e.g., a different polynomial formula (an equation of a curve) as the formula that connects the first local maximum point to the second local maximum point, or may increase the values of the first and second local maximum points further and perform linear interpolation or other type of interpolation processing based on the increased values. In other words, the anomaly detection program 104 needs to perform processing for upwardly correcting (increasing) the values of the points (performance values) for the times in between the first and second local maximum points.

Next, the anomaly detection program 104 replaces the information on the first local maximum point with the infoimation on the second local maximum point, and stores the information on the second local maximum point as infoimation on a first local maximum point (S315).

The anomaly detection program 104 refers to the prediction data table 400 and determines whether the time of the first local maximum point is the time of the last performance value in the corrected upper limit 404 of the prediction data table 400 (S316).

If the time of the first local maximum point is the time of the last performance value in the corrected upper limit 404 (S316: Yes), the anomaly detection program 104 executes processing of S317, and if the time of the first local maximum point is not the time of the last performance value in the corrected upper limit 404 (S316: No), the anomaly detection program 104 executes the processing of S313.

In S317 to S321, the anomaly detection program 104 corrects (or recorrects) the upper limit values of the normal range by performing smoothing by interpolation between local minimum values.

Specifically, the anomaly detection program 104 identifies the performance value for the first time in the prediction data table 400 and stores the performance value as a first focal minimum point (S317). More specifically, in the prediction data table 400, the anomaly detection program 104 takes the value of the corrected upper limit 404 on the record with the timestamp 401 indicating the earliest time, links the value to its corresponding time, and stores the value and its corresponding time as a “local minimum point 1.”

The anomaly detection program 104 identifies fluctuations of the performance values from the time of the first local minimum point to a time which is Y after the time of the first local minimum point, and stores the local minimum. value (or the minimum value) closest to the first local minimum point and its corresponding time as a second local minimum point (S318). Specifically, the anomaly detection program 104 identifies the local minimum value (or the minimum value) from the performance values within the period of Y starting from the time of the “local minimum value 1” by referring to the records in the prediction data table 400, links the identified performance value to its corresponding time, and stores the value and its corresponding time as a “local minimum point 2.” In other words, the first local minimum point and the second local minimum point are two local minimum points adjacent to each other in Y.

The anomaly detection program 104 calculates performance values in between the time of the first local minimum value and the time of the second local minimum value in the prediction data table 400 by performing linear interpolation based on the first and second local minimum values, and stores the calculated values in the prediction data table 400 (S319).

Specifically, for example, the anomaly detection program 104 performs linear interpolation based on the first and second local minimum points. More specifically, the anomaly detection program 104 generates a formula for a line segment connecting the first local minimum point to the second local minimum point (a time−performance value formula), applies the generated line segment formula to each of the times in the timestamp 401 of the records in which times in between the time of the first local minimum point and the time of the second local minimum point are registered in the timestamp 401 in the prediction data table 400, thereby calculates the performance values at those times, and sets the calculated performance values in the corrected upper limit 404 of the corresponding records.

Note that the anomaly detection program 104 may perform interpolation processing other than the linear interpolation described herein. For example, the anomaly detection program 104 may use, e.g., a different polynomial formula (an equation of a curve) as the formula that connects the first local minimum point to the second local minimum point, or may increase or decrease the values of the first and second local minimum points further and perform linear interpolation or other type of interpolation processing based on the increased or decreased values. In other words, the anomaly detection program 104 needs to perform processing for making a minor correction downward on (i.e., decreasing) the values of the points (performance values) for the times in between the first and second local minimum points.

Next, the anomaly detection program 104 replaces the information on the first local minimum point with the information on the second local minimum point, and stores the information on the second local minimum point as information on a first local minimum point (S320).

The anomaly detection program 104 refers to the prediction data table 400 and determines whether the time of the first local minimum point is the time of the last performance value in the corrected upper limit 404 of the prediction data table 400 (S321).

If the time of the first local minimum point is the time of the last performance value in the corrected upper limit 404 (S321: Yes), the corrected normal range calculation processing S310 ends, and if the time of the first local minimum point is not the time of the last performance value in the corrected upper limit 404 (S321: No), the anomaly detection program 104 executes the processing of S318.

Note that the above smoothing by interpolation between local minimum values may be executed only when the performance values have decreased. When performance values have decreased, the smoothing by interpolation between local minimum values tends to be strongly manifested; thus, an extreme increase in the upper limit value caused by the smoothing by interpolation between local maximum values is reduced, which consequently helps prevent false negative anomaly detection.

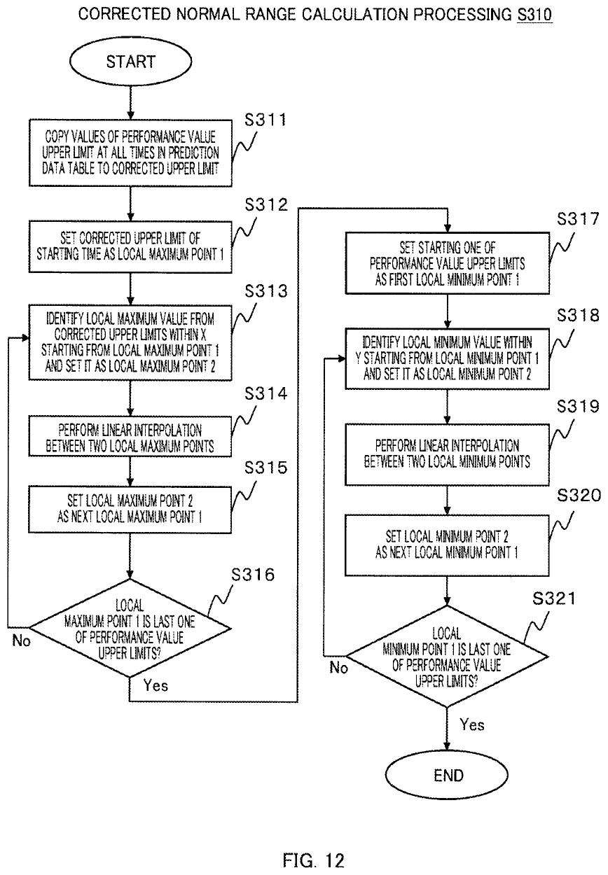

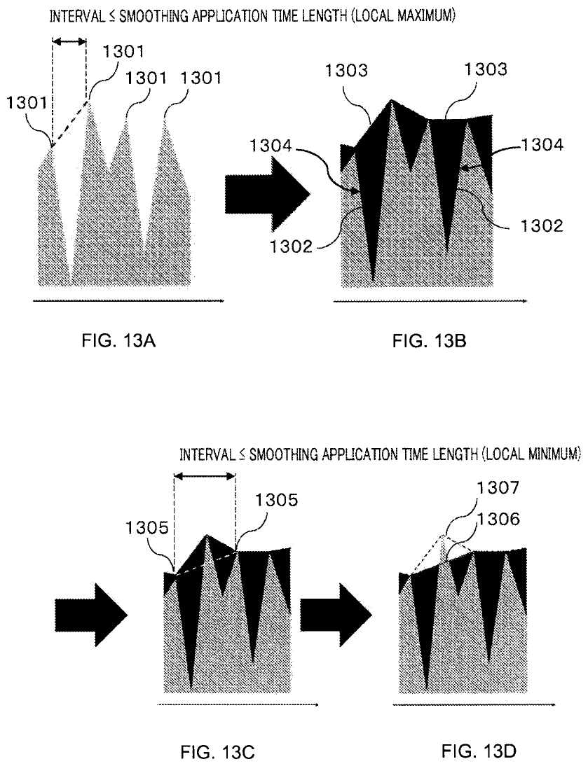

Next, FIG. 13 is a diagram illustrating what is performed in the corrected normal range calculation processing S310. As shown in FIG. 13A, considered here is a case where the prediction values of the upper limit values of a normal range repeat an increase and a decrease markedly to have a plurality of local maximum points 1301. Also, the time interval between the local maximum points 1301 is equal to or smaller than the local maximum value smoothing maximum time interval X.

In this case, as shown in FIG. 13B, first, the processing for smoothing by interpolation between local maximum values (S312 to S316) is performed so that upper limit values 1302 of the times in between the local maximum points may be corrected and increased to values 1303 close to the values of the local maximum points based on linear interpolation between the local maximum points. In other words, the normal range based on those corrected values 1303 is expanded by the areas 1304 colored in black, which as a result makes it easier for an actual measured value of a performance parameter to fall within the normal range and thus reduces unwanted anomaly detection.

Next, as shown in FIG. 13C, the time interval between local minimum points 1305 based on the fluctuations of the upper limit values corrected by the smoothing by interpolation between local maximum values is equal to or smaller than the local minimum value smoothing maximum time interval Y here. Then, the processing for smoothing by interpolation between local minimum values (S317 to S321) is performed so that upper limit values at the times between the local minimum points 1305 are corrected and decreased to values 1306 close to the values of the local minimum points 1305 as shown in FIG. 13D based on linear interpolation between the local minimum points 1305. Thus, the processing for smoothing by interpolation between local minimum values can lower the possibility of false negative detection of anomalies which occurs when the normal range is excessively interpolated by the smoothing by interpolation between local maximum values.

### <Anomaly Detection Processing>

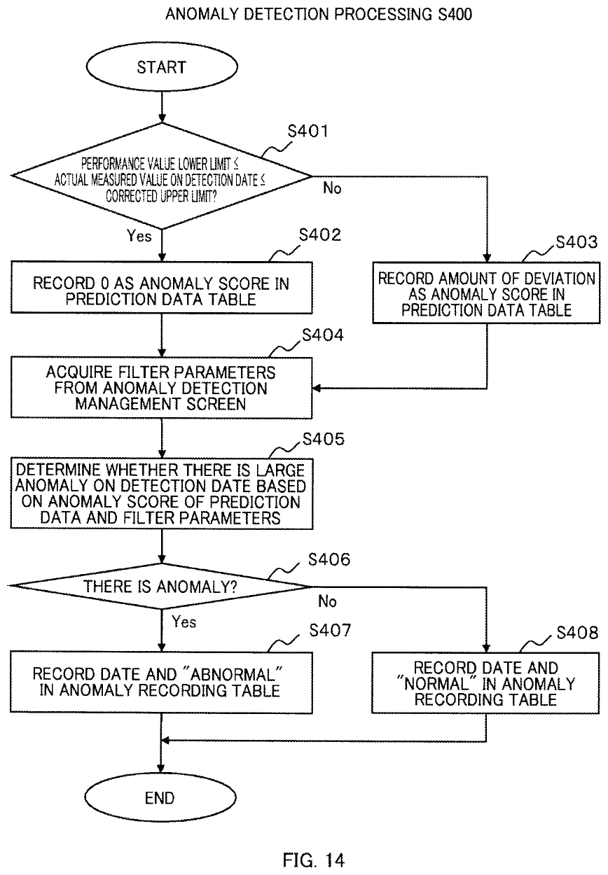

Next, FIG. 14 is a flowchart illustrating details of the anomaly detection processing S400.

The anomaly detection program 104 determines, for each actual measured value in the prediction data table 400, whether the actual measured value is within the range defined by the performance lower value and the corrected upper limit value (whether the actual measured value is equal to or above the performance lower limit value and equal to or below the corrected upper limit value) (S401). Specifically, the anomaly detection program 104 acquires the content of each record in the prediction data table 400 and compares the value of the performance value lower limit 402, the value of the corrected upper limit 404, and the value of the actual measured value 405 in each record acquired, in terms of which is larger and which is smaller.

If a given actual measured value (hereinafter referred to as the present actual measured value) is within the range defined by the performance lower limit value and the corrected upper limit value (S401: Yes), the anomaly detection program 104 executes processing of S402 on that actual measured value, and if the given actual measured value (the present actual measured value) is not within the range defined by the performance lower limit value and the corrected upper limit value (S401: No), the anomaly detection program 104 executes processing of S404 on that actual measured value.

In S402, the anomaly detection program 104 sets the anomaly score of the present actual measured value to 0 (zero). Specifically, in the prediction data table 400, the anomaly detection program 104 stores “0” in the anomaly score 406 of the record for the present actual measured value.

Then, the anomaly detection program 104 acquires filter parameters (the minimum continuance period, the minimum parameter value, and the minimum anomaly score) from the time period threshold setting part 231, the actual measured threshold setting part 232, and the prediction-actuality difference threshold setting part 233 on the anomaly detection management screen 200 and stores the acquired filter parameters in the filter parameter table 600 (S404). After that, processing of S405 is performed.

Meanwhile, in S403, the anomaly detection program 104 sets, as an anomaly score, the amount of deviation of the present actual measured value from the corrected upper limit value or the performance lower limit value. Specifically, in the prediction data table 400, the anomaly detection program 104 stores a value in the anomaly score 406 of the record for the present actual measured value, the value being obtained by subtracting the value of the corrected upper limit 404 of the same record from the value of the actual measured value 405 of the same record (or by subtracting the performance value lower limit 402 of the same record from the actual measured value 405 of the same record). Then, the processing of S404 is performed.

In S405, the anomaly detection program 104 determines, based on the filter parameters, whether the present actual measured value is an anomaly. For example, the anomaly detection program 104 determines whether the present actual measured value is a value larger than the minimum parameter value continuously for the minimum continuance time period or longer and also has an anomaly score larger than the minimum anomaly score.

Note that the anomaly detection program 104 may apply the minimum parameter value and the minimum anomaly score to the present actual measured value in each of the times, or may find the average of the actual measured values 405 and the average of the anomaly scores in a certain time period (e.g., one hour) and apply the minimum parameter value and the minimum anomaly score to those averages.

If the present actual measured value is an anomaly (S406: Yes), the anomaly detection program 104 executes processing of S407, and if the present actual measured value is not an anomaly (S406: No), the anomaly detection program 104 executes processing of S408.

In S408, the anomaly detection program 104 records a determination result in the anomaly recording table 700, indicating that there is no anomaly on the date of measurement of the present actual measured value (the detection date). Specifically, the anomaly detection program 104 stores the detection date of the present actual measured value (which corresponds to the timestamp 401 in the prediction data table 400) in the date 701 of the anomaly recording table 700, records “normal” in the abnormal/normal 702, and then executes processing of S409.

In S407, the anomaly detection program 104 records a determination result in the anomaly recording table 700, indicating that there is an anomaly on the measurement data (the detection date) of the present actual measured value. Specifically, the anomaly detection program 104 stores the detection date of the present actual measured value (which corresponds to the timestamp 401 in the prediction data table 400) in the date 701 of the anomaly recording table 700, records “abnormal” in the abnormal/normal 702, and then executes the processing of S409.

Note that the anomaly recording table 700 created by the above anomaly detection processing S400 is used in the later normal range correction processing S300 to determine whether the corrected normal range calculation processing S310 is necessary.

In S409, the anomaly detection program 104 displays results of the processing performed thus far in the result display part 270 of the anomaly detection management screen 200. The anomaly detection processing S400 thus ends.

Here, information displayed in the result display part 270 is described using the anomaly detection management screen 200 exemplified in FIG. 6.

The result display part 270 includes a behavior display part 240 and a detection result display part 250. Displayed in the behavior display part 240 is a temporal change 241 in the performance parameter used for learning of the prediction model. Specifically, the temporal change 241 in the performance parameter is a temporal change in the performance value of the target VM selected in the target VM selecting part 201 and the performance value selecting part 202, in a period selected in the learning period setting part 211.

In the behavior display part 240, an anomaly symbol 242 (which is, in FIG. 6, a symbol where an exclamation mark is superimposed on a triangle) may be displayed. The anomaly symbol 242 is displayed when it is determined that there is an anomaly in the performance parameter used for learning of the prediction model.

Displayed in the detection result display part 250 are a change 251 in the actual measured value of the performance parameter in the prediction period specified in the prediction period setting part 212, a normal range 253 of the performance parameter, and upper and lower limit values 254 (an upper limit value 254a and a lower limit value 254b) of the performance parameter.

Also, in the detection result display part 250, an anomaly symbol 252 (which is, in FIG. 6, a symbol where an exclamation mark is superimposed on a triangle) may be displayed. The anomaly symbol 252 is displayed when it is determined that the actual measured value of the performance parameter deviates from the range defined by the upper and lower limit values 254 (i.e., when there is an anomaly in the performance parameter).

Note that in a period to which the normal range correction processing is applied, the upper limit values of the upper and lower limit values 254 are the upper limit values of the corrected normal range. Meanwhile, in a period to which the normal range correction processing is not applied, the upper limit values of the upper and lower limit values 254 are the upper limit values of the normal range.

### <Advantageous Effects Offered by the Corrected Normality Range Calculation Processing>

Next, with reference to some drawings, a description is given of how the corrected normal range calculation processing S310 reduces unwanted anomaly detection.

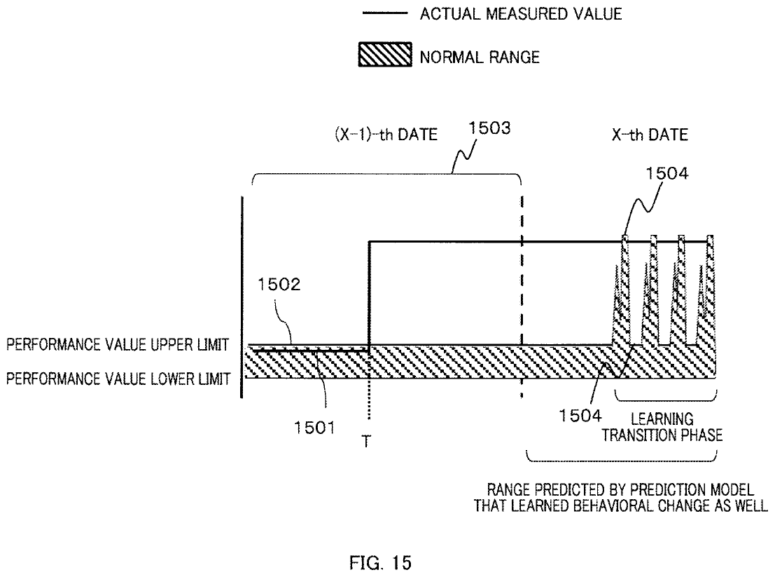

FIG. 15 is a diagram showing an example of the relation between the behavior of actual measured values of a performance parameter and a normal range predicted by a prediction model.

As shown in FIG. 15, a case is considered here where an actual measured value 1501 of a performance parameter was staying at or below upper limit values 1502 defining the normal range for the performance parameter, but then rises steeply and greatly at a certain time T on the (X−1)-th date, deviates from the upper limit values 1502, and stays at the high value after that.

In this case, on the X-th date, a prediction model lea is the upper limit values (the normal range) of the performance parameter by using, as leaiiiing data, actual measured values 1503 of the performance parameter on the (X−1)-th date including the times before and after the time T. Then, reflecting the steep rise of the actual measured value 1501 of the performance parameter on the (X−1)-th date, the prediction model becomes an unstable model. For example, the upper limit values 1504 of the performance parameter predicted by this prediction model are values such that, for every prediction, drastic increase and decrease are repeated in a short period, reflecting the actual measured values of the performance parameter before and after the time T.

In other words, this prediction model is a model improperly interpreting the steep rise of the actual measured value 1501 of the performance parameter at the time T on the (X−1)-th date (or specifically, the prediction model determines that a value of the performance parameter after the steep rise is abnormal even though the value is in fact no longer abnormal as of the X-th date), and thus, this prediction model can be said to be still in a learning transition phase. In such a leaiiiing transition phase, based on the unstable normal range values, the management calculator 100 frequently determines that there is an anomaly when a measured value of the performance parameter is in fact not an anomaly.

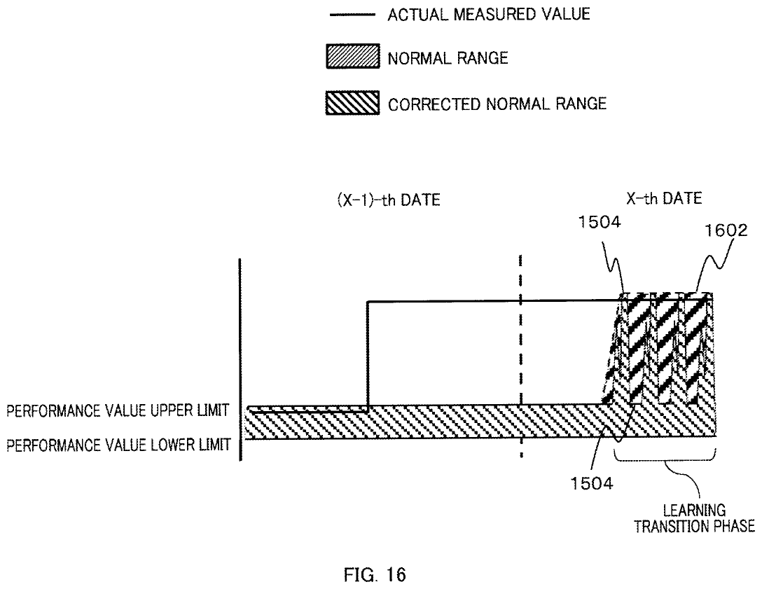

Next, FIG. 16 is a diagram showing an example of the relation between the behavior of actual measured values of a performance parameter and a noimal range corrected by the corrected normal range calculation processing S310.

As shown in FIG. 16, the corrected normal range calculation processing S310 raises (increases) the upper limit values of the performance parameter predicted by the prediction model based on the local maximum points of the above repetitively increasing and decreasing upper limit values 1504 of the performance parameter and corrects them to corrected upper limit values 1602. As a result, the management calculator 100 can correctly determine if there is an anomaly in the value of the performance parameter based on these corrected upper limit values 1602 (i.e., can reduce unwanted anomaly detection).

As thus described, the management calculator 100 (anomaly detection apparatus) of the present embodiment predicts fluctuations of a normal range for values of a performance parameter in a prediction period, corrects the upper limit values of the normal range based on an upper limit value at a local maximum point identified from fluctuating upper limit values of the predicted normal range (first correction processing), corrects the upper limit values of the corrected normal range based on an upper limit value at a local minimum point identified from the fluctuating upper limit values of the corrected normal range (second correction processing), and if it is determined that an actual measured value of the performance parameter in the prediction period does not fall within the corrected normal range, displays a result indicative of that on the anomaly detection management screen 200.

In other words, the anomaly detection apparatus of the present embodiment expands the noimal range by correcting the upper limit values of the calculated noimal range based on the local maximum values and then reduces the expanded normal range by recorrecting the normal range based on the local minimum values of the noimal range. This enables proper correction of the normal range and stable anomaly determination when the anomaly determination can be unstable because of large fluctuations of the calculated noimal range.

In this way, according to the anomaly detection apparatus of the present embodiment, an anomality in a parameter value can be accurately detected with simple processing. For example, unwanted false positive detection is reduced, and accurate anomaly detection can be achieved. Also, there is no need for introducing an additional parameter such as a reference period.

Also, the anomaly detection apparatus of the present embodiment can predict fluctuations of a normal range for a value of a performance parameter in a prediction period by using a prediction model that takes a period for the performance parameter as an input value and gives the normal range for a value of the performance parameter in that period as an output value.

Thus, the upper limit values of a performance parameter and the like can be calculated with high precision.

Also, the anomaly detection apparatus of the present embodiment updates the prediction model as needed based on measured values of the performance parameter in the prediction period.

Thus, the accuracy of the prediction model can be improved more.

Also, the anomaly detection apparatus of the present embodiment corrects the upper limit values of the noimal range only when there is an anomaly in a value of the performance parameter before the prediction period.

Thus, the processing efficiency for anomaly detection can be improved because the upper limit values of the normal range are corrected only when the correction of the normal range is needed for accurate anomaly detection.

Also, the anomaly detection apparatus of the present embodiment determines if a value of a performance parameter is an anomaly by determining whether a value of the parameter at a time before a prediction period exceeds the minimum parameter value, whether the value of the performance parameter stays above a threshold continuously for the minimum continuous time period or longer, or whether the anomaly score of the performance parameter exceeds the minimum anomaly score.

This helps prevent too frequent anomaly determinations.

Also, the anomaly detection apparatus of the present embodiment identifies upper limit values at two local maximum points that are adjacent to each other in the local maximum value smoothing maximum time interval from the fluctuating upper limit values of the normal range calculated by a prediction model, calculates values in between the identified two local maximum points by performing linear interpolation between those local maximum points, and corrects the upper limit values of the normal range in between the two local maximum points based on the calculated values (the first correction processing).

Increasing the upper limit values in between the two local maximum points based on the local maximum points can increase the upper limit values of the normal range as a whole and prevent erroneous determinations where a value of the performance parameter frequently exceeds an upper limit value and is consequently determined as an anomaly.

Further, after the first correction processing, the anomaly detection apparatus of the present embodiment identifies upper limit values at two local minimum points that are adjacent to each other in the local maximum value smoothing maximum time interval from the fluctuating upper limit values of the noimal range defined by the values obtained by the linear interpolation and the upper limit values at the local maximum points in the noimal range, calculates values in between the identified two local minimum points by performing linear interpolation between those local minimum points, and corrects the upper limit values of the normal range in between the two local minimum points based on the calculated values (the second correction processing).

Increasing the upper limit values in between the two local minimum points based on the local minimum points can slightly decrease the upper limit values of the normal range that have been increased earlier and thus prevent erroneous determinations where an abnormal value of the performance parameter does not exceed the upper limit value and consequently fails to be determined as an anomaly.

Also, the anomaly detection apparatus of the present embodiment executes the second correction processing only when fluctuations of the upper limit values of the normal range were reduced in the interpolation processing.

Because the second correction processing is executed only when the upper limit values have a decreasing tendency in which case the advantageous effects of the second correction processing are manifested strongly, efficient upper limit correction processing can be performed.

The present disclosure is not limited to the above embodiment and can be implemented using any constituents without departing from the gist thereof. The embodiment and modifications described above are mere examples, and the present disclosure is not limited to them as long as the features of the present disclosure are not impaired. While various embodiments and modifications have been described above, the present disclosure is not limited to them. The present disclosure also includes other modes conceivable within the scope of the technical scope of the present disclosure.

For example, part of the hardware that each apparatus in the present embodiment has can be provided in a different apparatus.

Also, the programs for the anomaly detection apparatus maybe provided in a different apparatus. A certain program may be fainted by a plurality of programs, or a plurality of programs may be integrated into one program.

Also, although the present embodiment describes an example of anomaly detection of a performance value measured in operations management of an IT system, the present disclosure is not limited to this example and can be applied to other cases. For example, the present disclosure can be applied to chronological data of various kinds such as the temperature or oscillation of factory equipment, or a flow rate of water, gas, or electricity.

What is claimed is:

1. An anomaly detection apparatus comprising a processing device configured to execute
prediction processing to predict fluctuations of a normal range for a value of a parameter in a specified period,
correction processing to identify an upper limit value at a local maximum point from fluctuating upper limit values of the predicted noimal range, correct the upper limit values of the normal range based on the upper limit value at the local maximum point identified, identify an upper limit value at a local minimum point from fluctuating upper limit values of the corrected noimal range, and correct the upper limit values of the corrected normal range based on the upper limit value at the local minimum point identified, and
anomaly detection processing to acquire a value of the parameter in the specified period, determine whether the value of the parameter acquired falls within the corrected normal range, and output predetermined information when determining that the value of the parameter acquired does not fall within the corrected noimal range.

2. The anomaly detection apparatus according to claim 1, comprising a storage device configured to store a prediction model that takes a period for the parameter as an input value and gives a normal range for a value of the parameter in the period as an output value, wherein
the processing device predicts the fluctuations of the normal range for a value of the parameter in the period by inputting information on the specified period into the prediction model.

3. The anomaly detection apparatus according to claim 2, wherein
the processing device updates the prediction model based on the acquired value of the parameter in the specified period.

4. The anomaly detection apparatus according to claim 1, wherein
the processing device determines whether there was an anomaly in a value of the parameter before the specified period, and executes the correction processing only when determining that there was an anomaly in the value of the parameter.

5. The anomaly detection apparatus according to claim 4, wherein
the processing device determines whether there was an anomaly in the value of the parameter before the specified period by determining whether a value of the parameter at a time before the specified period exceeds a threshold, whether the value of the parameter stays above a threshold continuously for a predetermined period or longer, or whether a difference between the value of the parameter and a threshold exceeds a predetermined value at the time.

6. The anomaly detection apparatus according to claim 1, wherein
in the correction processing, the processing device executes first correction processing to identify upper limit values at two local maximum points adjacent to each other in a predetermined time period from the fluctuating upper limit values of the predicted normal range, calculate values in between the identified two local maximum points by performing linear interpolation between the two local maximum points, and correct the upper limit values of the normal range in between the two local maximum points based on the calculated values.

7. The anomaly detection apparatus according to claim 6, wherein
after the first correction processing, the processing device executes second correction processing to identify upper limit values at two local minimum points adjacent to each other in a predetermined time period from the fluctuating upper limit values of the normal range identified based on the calculated values and the upper limit values at the identified local maximum points in the normal range, calculate values in between the identified two local minimum points by performing linear interpolation between the two local minimum points, and correct the upper limit values of the normal range in between the two local minimum points based on the calculated values.

8. The anomaly detection apparatus according to claim 7, wherein
in the correction processing, the processing device determines whether fluctuation of the upper limit values of the calculated noimal range was reduced, and executes the second correction processing only when deteimining that the fluctuation of the upper limit values was reduced.

9. An anomaly detection method implemented by an information processing apparatus, comprising executing
prediction processing to predict fluctuations of a noimal range for a value of a parameter in a specified period,
correction processing to identify an upper limit value at a local maximum point from fluctuating upper limit values of the predicted noimal range, correct the upper limit values of the noimal range based on the upper limit value at the local maximum point identified, identify an upper limit value at a local minimum point from fluctuating upper limit values of the corrected noimal range, and correct the upper limit values of the corrected normal range based on the upper limit value at the local minimum point identified, and
anomaly detection processing to acquire a value of the parameter in the specified period, determine whether the value of the parameter acquired falls within the corrected noimal range, and output predetermined information when deteimining that the value of the parameter acquired does not fall within the corrected noimal range.

10. A non-transitory computer-readable medium recording an anomaly detection program that causes an information processing apparatus to execute
prediction processing to predict fluctuations of a normal range for a value of a parameter in a specified period,
correction processing to identify an upper limit value at a local maximum point from fluctuating upper limit values of the predicted normal range, correct the upper limit values of the normal range based on the upper limit value at the local maximum point identified, identify an upper limit value at a local minimum point from fluctuating upper limit values of the corrected normal range, and correct the upper limit values of the corrected normal range based on the upper limit value at the local minimum point identified, and
anomaly detection processing to acquire a value of the parameter in the specified period, determine whether the value of the parameter acquired falls within the corrected normal range, and output predetermined information when determining that the value of the parameter acquired does not fall within the corrected normal range.
